(19) United States
(12) Patent Application Publication
(10) Pub. No.: US 2017/0057841 A1
(43) Pub. Date: Mar. 2, 2017

(54) LIQUID PURIFICATION SYSTEM

(71) Applicant: aqUV, LLC, Gainesville, FL (US)

(72) Inventors: Daniel Blood, Valparaiso, IN (US); Robert Damitz, Gainesville, FL (US); Erica Gonzaga, Gainesville, FL (US)

(21) Appl. No.: 15/248,751

(22) Filed: Aug. 26, 2016

Related U.S. Application Data
(60) Provisional application No. 62/210,780, filed on Aug. 27, 2015.

(51) Int. Cl. C02F 1/32

(52) U.S. Cl. CPC C02F 1/325; C02F 2201/326; C02F 2201/322

(57) ABSTRACT

A liquid purification system is provided that includes a liquid holding device configured to hold liquid and an ultra-violet (UV) disinfecting system disposed in a base adjacent to a closed end of the liquid holding device. A power-generating system wirelessly powers the UV disinfecting system.

### CROSS-REFERENCE TO RELATED APPLICATIONS

This application claims the benefit of U.S. Provisional Patent Application Ser. No. 62/210,780 entitled “WATER PURIFICATION SYSTEM” filed on Aug. 27, 2015. The entirety of the above-noted application is incorporated by reference herein.

### ORIGIN

The innovation disclosed herein relates to a liquid purifying system and more specifically, to a portable liquid purifying system utilizing ultraviolet light disinfection.

### BACKGROUND

As many as 2,000 children die every day from waterborne illness. The spread of diseases such as cholera may be prevented by treating or disinfecting all water used for drinking and cooking. Boiling water is the most common disinfection technique in developing countries but it has several drawbacks. Boiling requires a fuel source and is time-intensive taking up to an hour or more to boil and cool gallons of water. Chlorine disinfection can be effective, but not everyone has access to bleach or chlorine tablets. Additionally, if overdosed, chlorine has the potential to poison the user or create harmful disinfection by-products. There exists an urgent need for better water purification and sanitation methods, especially in underdeveloped countries that lack reliable infrastructure and resources for conventional treatment.

Ultraviolet (UV) light disinfection is a proven technology used to disinfect surfaces, material and liquids in various medical, industrial and commercial applications. It is especially useful for destroying pathogenic microorganisms in drinking water. Many pathogenic microorganisms are highly sensitive to UV disinfection and can be destroyed with limited treatment time. The Environmental Protection Agency (EPA) includes UV treatment as a proper disinfection method for municipal drinking water in the United States.

NSF/ANSI Standard 55 establishes the requirements for proper water treatment by use of point of use (POU) devices utilizing UV disinfection. These POU devices are essential in underdeveloped countries where proper municipal drinking water is not available. POU devices range in size from personal filters to larger units that treat water for an entire household, neighborhood or village. UV disinfection is an ideal method for POU devices since it does not require expensive replacement parts like membrane filters that clog and need to be exchanged over extended periods of use.

A reliable energy source, however, is needed to provide the necessary power to operate the UV lights. Reliable energy sources may not be easily accessible in underdeveloped countries. Batteries or grid electricity may power POU devices, but replacement batteries are expensive and not always available or easy to find in remote areas. In addition, depending on the setting, users may need to submerge the apparatus (in a river or lake, for example) in order to collect water for disinfection. The submersion of the apparatus in water may cause significant damage if electrical systems come into contact with the water.

Cross-contamination is also a challenge while handling clean water in underdeveloped areas. Sharing a single water container with multiple people can contaminate otherwise clean water. Carrying clean water in dirty containers may also be a source of contamination. Open containers have the potential of collecting insects and fecal matter from animals if left unattended for long periods of time. A self-contained, personal use disinfection device may prevent cross-contamination from users and external contaminants.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In an aspect of the innovation, the innovation described herein utilizes UV disinfection in a portable apparatus coupled with a sustainable method for powering the UV system. The invention includes a detachable base that wirelessly transmits electrical energy, and the base may contain an internal battery allowing the user to store energy for various cycles of disinfection. The battery may be charged through solar energy, mechanical energy, or conventional sources such as grid power. Power is transferred wirelessly, from the detachable base to the purifying apparatus, through inductive coupling, protecting all electrical systems from potential water damage since no electrical components are exposed.

In another aspect of the innovation, a liquid purification system is disclosed that includes a liquid holding device configured to hold liquid, an ultra-violet (UV) disinfecting system disposed in a base adjacent to a closed end of the liquid holding device, and a power-generating system that wirelessly powers the UV disinfecting system, wherein the UV disinfecting system includes at least one UV light source that when activated disinfects the liquid.

In yet another aspect of the innovation a liquid treatment apparatus is disclosed that includes a portable liquid holding device configured to hold liquid, at least one ultra-violet (UV) light source that when activated disinfects the liquid, and an inductive coil that receives power from an external power source to thereby power the at least one UV light source.

In still yet another aspect of the innovation, a method of disinfecting a liquid is disclosed that includes setting a liquid holding device on a power generating base, detecting the presence of the liquid holding device on the power generating base with a proximity detector, inducing a voltage in an inductive charging coil from a rechargeable power source, wirelessly inducing a voltage in an inductive receiving coil from the inductive charging coil, powering a driver circuit from the inductive receiving coil, activating the at least one ultra-violet (UV) light source from the driver circuit, and disinfecting the liquid inside the liquid holding device.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is a plan view illustration of an example liquid holding device in accordance with an aspect of the innovation.

FIG. 2 is a side view cross section view taken along line 2-2 of the liquid holding device of FIG. 1 in accordance with an aspect of the innovation.

FIG. 3 is a perspective view of a power-generating system and base for the liquid purification system in accordance with an aspect of the innovation.

FIG. 4 is a top view of the power-generating system and base for the liquid purification system in accordance with an aspect of the innovation.

FIG. 5 is a cross section view taken along line 5-5 of the power-generating system and base for the liquid purification system in accordance with an aspect of the innovation.

FIG. 6 is an alternate embodiment of a liquid holding device in accordance with an aspect of the innovation.

FIG. 7 is a flow chart illustrating a method of disinfecting liquid inside the liquid holding device in accordance with an aspect of the innovation.

FIGS. 8 and 9 illustrate a cross-section view and a plan view of another example embodiment of a liquid purification system in accordance with an aspect of the innovation.

FIG. 10 is a front perspective view of a power-generating system and base for the liquid purification system of FIGS. 8 and 9 in accordance with an aspect of the innovation.

FIG. 11 is a rear perspective view of a power-generating system and base for the liquid purification system of FIGS. 8 and 9 in accordance with an aspect of the innovation.

FIG. 12 is a side view of the power-generating base for the liquid purification system of FIGS. 8 and 9 in accordance with an aspect of the innovation.

FIG. 13 is a cross section view taken along line 13-13 of FIG. 12 of the power-generating system and base for the liquid purification system of FIGS. 8 and 9 in accordance with an aspect of the innovation.

FIG. 14 is a cross section view taken along line 14-14 of FIG. 12 of the power-generating system and base for the liquid purification system of FIGS. 8 and 9 in accordance with an aspect of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness, orientation, configuration, etc.), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Disclosed herein is a portable liquid purification system that utilizes ultraviolet (UV) disinfection and employs inductive, wireless transmission of electric energy to the

UV system. The innovation includes advancements in power generation and an additional mixing mechanism that reduces disinfection times. It is to be understood that although water is used as an example herein, any liquid that requires disinfecting can utilize the innovative liquid purification system. Thus, the use of water herein is for illustrative purposes only and is not intended to limit the scope of the innovation.

UV light at a wavelength ranging between 200 and 300 nm is effective at destroying or inactivating microorganisms including but not limited to bacteria, viruses and parasites. The innovation described herein incorporates UV disinfection in a portable apparatus, which takes the shape of a bottle. One or more UV lamps primarily emitting light at a wavelength less than or equal to 400 nm are incorporated within the bottle. These lights serve the dual purpose of disinfecting the liquid and also sanitizing the container. The narrow opening at the top of the bottle prevents any contamination from the user (i.e. dirty hands) and/or any other external contamination. Once the UV lamps sanitize the empty bottle, the device is considered appropriate for use and the user may utilize the container for the collection and disinfection of a liquid, such as but not limited to water.

The innovation described here uses a wireless transmission of energy in order to protect essential electric systems and simplify operation for the user. A wireless receiver is embedded within the base of the bottle, which can be coupled with any compatible inductive transmitter of electrical energy. The base that transmits electric energy is completely detached from the disinfecting apparatus. Once the user has filled the apparatus with a liquid, the detachable base is either attached, or placed under the bottle in order to operate the UV lamp(s). An individual base may power several bottles. The detachable base may contain a battery to store electric energy and/or may contain a solar panel or mechanical crank to charge the battery.

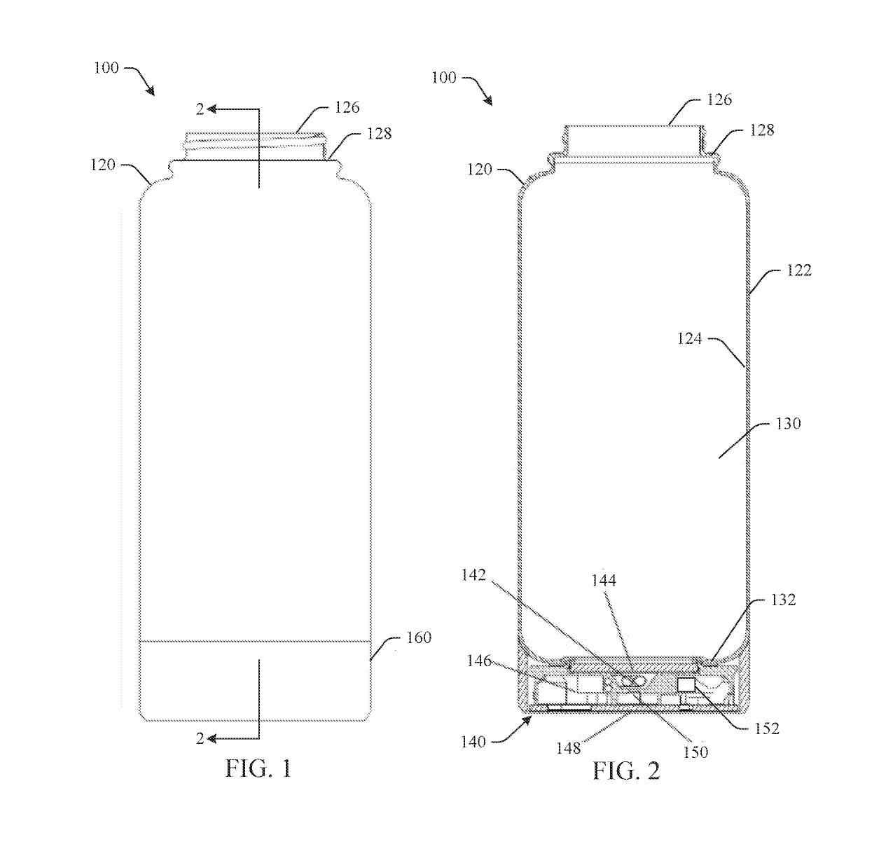

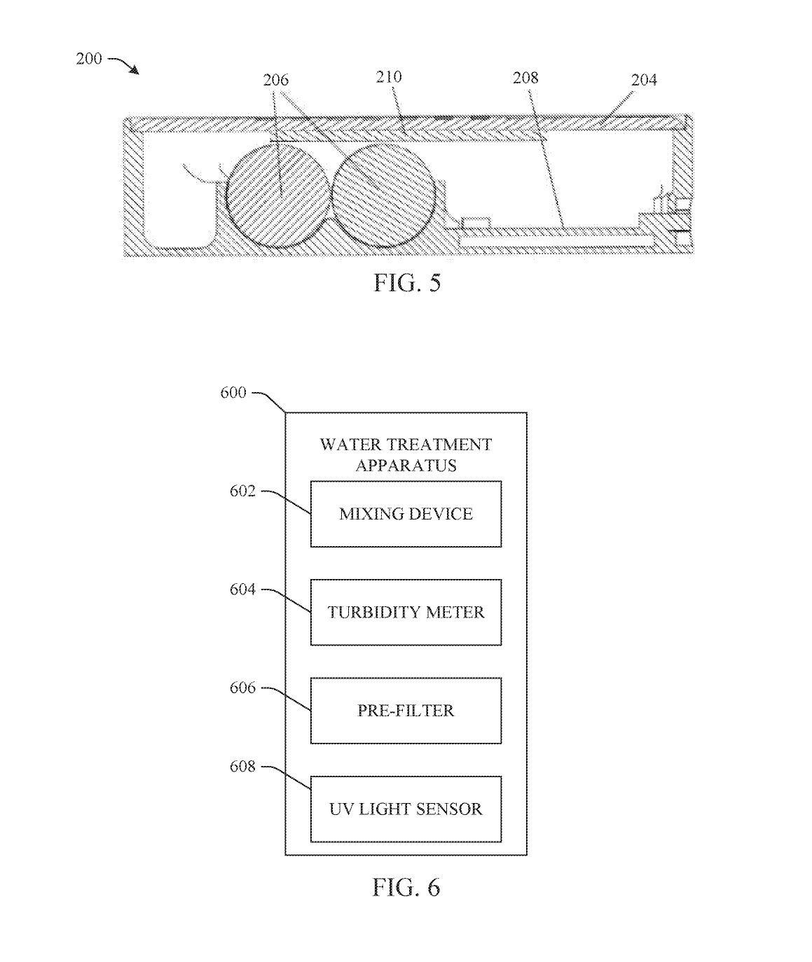

Referring now to the drawings, FIGS. 1-5 are illustrations of an innovative liquid purification system that includes a liquid treatment apparatus 100 and a power-generating system 200 in accordance with an aspect of the innovation. The liquid purification system is a portable system (e.g., can be easily carried by a person), but it is to be understood that the system can be incorporated into a semi-permanent or permanent system without departing from the scope of the innovation.

The liquid treatment apparatus 100 includes a liquid holding device (e.g., a container, vessel, a bottle (water bottle), jar, etc. that is easily carried by a person) 120 configured to hold a liquid, such as but not limited to water, a UV disinfecting system 140, and a waterproof, seal-tight protective base 160 configured to house the disinfecting system 140.

Referring to FIGS. 1 and 2, the liquid holding device 120 has an external surface 122, an internal surface 124, an opening 126 defined at a first end (top) 128, a cavity 130 configured to receive the liquid via the opening 126, and a closed second (bottom) end 132. All or a portion thereof of the closed end 132 is made from a material that allows the transmission of UV light through the closed end 132 to disinfect the liquid within the liquid holding device 120. Among other things, the liquid holding device 120 can function as a disinfection chamber, a drinking vessel, a storage device, a transport device, etc.

The UV liquid disinfecting system 140 is disposed in the protective base 160 adjacent to the second end 132 of the liquid holding device 120 and is adapted to disinfect the liquid in the liquid holding device 120. The liquid disinfecting system 140 is fully sealed within the protective base 160. Thus, there are no exposed electrical components, thereby allowing the user to submerge the liquid treatment apparatus 100 while collecting water for treatment without damaging any components of the liquid disinfecting system 140.

The liquid disinfecting system 140 includes one or more ultra-violet (UV) light source(s) 142, protective covers 144 that cover and protect the UV light source(s) 142, a UV driver circuit 146 that drives the UV light source(s) 142, an inductive receiving coil 148 that powers the UV driver circuit 146, a UV detector 150, and an indicating device 152 that functions as a timer, alarm, a visual and/or audio indicator that communicates with the UV detector 150.

When the liquid holding device 120 is holding liquid, the UV light source(s) 142 disinfect/sanitize the liquid disposed inside the liquid holding device 120 for optimal water treatment and power consumption. When the liquid holding device 120 is empty (not holding liquid), the UV light source(s) 142, when activated, are intended to sanitize the internal surface 124 of the liquid holding device 120.

The protective covers 144 provide protection for the UV light source(s) 142 and may be made from quartz or any protective and transmissive sleeve (or sheath) that transmits UV light in the target wavelength range.

The UV detector 150 measures an output of UV light from the light source(s) 142 to determine an appropriate dosing of UV energy. Once the UV detector 150 has measured an appropriate light dosing to disinfect the volume of liquid, the indicating device 152 alerts the user that a minimum amount of time has passed for effective disinfection.

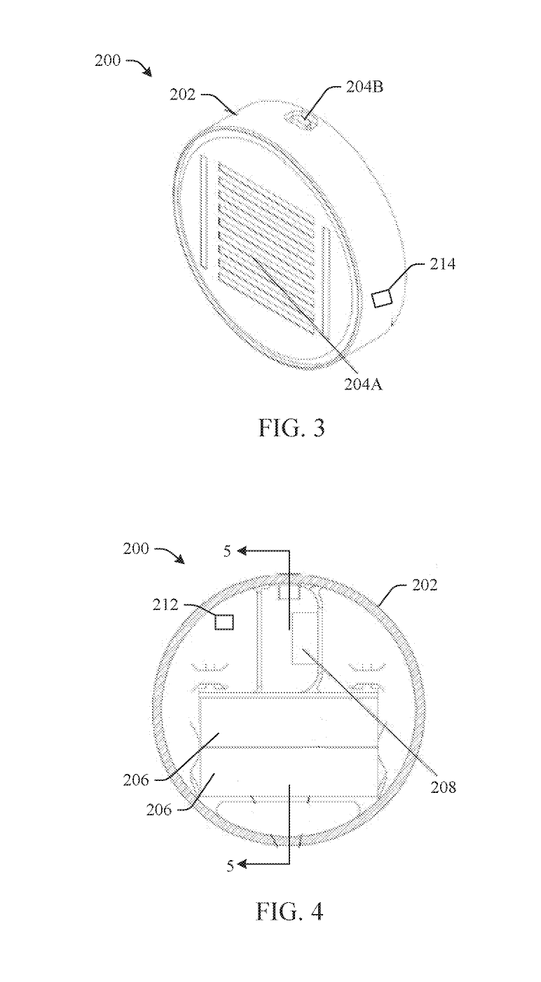

Referring to FIGS. 3-5, the power-generating system 200 is an external, detachable power source that utilizes wireless transfer of energy to power the UV driver circuit 146 described above. The power generating system 200 is housed in a detachable base 202 that can be coupled to the liquid holding device 120 by any suitable means, such as but not limited to a mechanical means, magnetic means, etc. The power-generating system 200 includes a charging power source 204, a rechargeable power source (e.g., batteries) 206, a voltage controller 208, an inductive charging coil 210, and a proximity detector 212 that detects when the liquid holding device 120 is on the detachable base 202, as will be described further below. A battery indicator 214 (e.g., digital, LED, etc.) can be provided to indicate battery life.

The charging power source 204 provides power to the rechargeable power source 206 to thereby recharge the rechargeable power source 206. The charging power source 204 may be any power source, such as but not limited to, a photovoltaic cell 204A, a USB connection 204B, a mechanical device (e.g., spring, crank, etc.), batteries, etc.

The voltage controller 208 converts the fixed voltage from the rechargeable power source 206 to a variable voltage to thereby induce a voltage in the inductive charging coil 210. The inductive charging coil 210 electrically couples with the inductive receiving coil 148, which allows the wireless transmission of power from the inductive charging coil 210 to the inductive receiving coil 148. The inductive receiving coil 148 provides power to the UV driver circuit 146, which in turn provides power to the UV light sources 142, as described above.

FIG. 6 is a block diagram illustration of alternate embodiments of a liquid treatment apparatus 600 in accordance with an aspect of the innovation. As light travels through a liquid or gaseous media, it loses intensity as the distance from the light source increases. Microorganisms closer to the light source (lamp) will be exposed to a higher intensity light and, therefore, will require less contact time for inactivation compared to microorganisms further away from the light source. Thus, agitating or mixing the liquid ensures that all microorganisms are equally exposed to the UV radiation, thereby improving the disinfection efficiency. Therefore, the liquid treatment apparatus 600 may include a mixing device 602 disposed in the liquid holding device 120 and is powered by the UV driver circuit described above. The mixing device 602 can mix the liquid in the liquid holding device 120 while the UV lamps are operating or not operating. Thus, the mixing device can operate independently of the UV light source(s) 142. The mixing device may be any type of mixing device, such as but not limited to, mechanical, magnetic, or ultrasonic systems.

Still referring to FIG. 6, the innovation may incorporate a turbidity meter (e.g., photodetector, light sensor, etc.) 604 used to determine the minimal amount of exposure time necessary for proper disinfection. Turbidity is a measure of the haziness of a liquid and therefore, how much light passes through the liquid. Increased turbidity is caused by suspended particles that readily absorb light. These suspended particles shield microorganisms from UV radiation, decreasing the effectiveness of disinfection. Table 1 below depicts the effect of turbidity on UV intensity and exposure time.

TABLE 1
Effect of Turbidity of Disinfection Time

| Turbidity | UV Intensity | Exposure time (sec) to |
|---|---|---|
| (NTU) | (mW/cm²) | achieve 5 mJ/cm² dose |
| 0.25 | 0.40 | 12.4 |
| 5 | 0.39 | 12.8 |
| 10 | 0.36 | 13.9 |
| 20 | 0.33 | 15 |

The turbidity meter 604 is placed within the liquid holding device 120 to measure the transmittance of light through the liquid. The turbidity meter 604 communicates with the other components (e.g., the UV driver circuit 146, the UV detector 150, etc.) to determine the amount of time or additional time is required to have the light source(s) 142 activated to compensate for the turbidity of the liquid by increasing the time that the UV light source is activated. Once the necessary time is reached the indicating device 152 alerts the user that the liquid is ready for consumption.

Still referring to FIG. 6, a pre-filter 606 can be included to remove turbidity and larger particles from incoming liquid. The pre-filter 606 may be reusable and/or removable so as to be cleaned and/or replaced. The pre-filter 606 may use gravity, water pressure, or any other form of pressure to pass liquid through the pre-filter and into the liquid holding device 120.

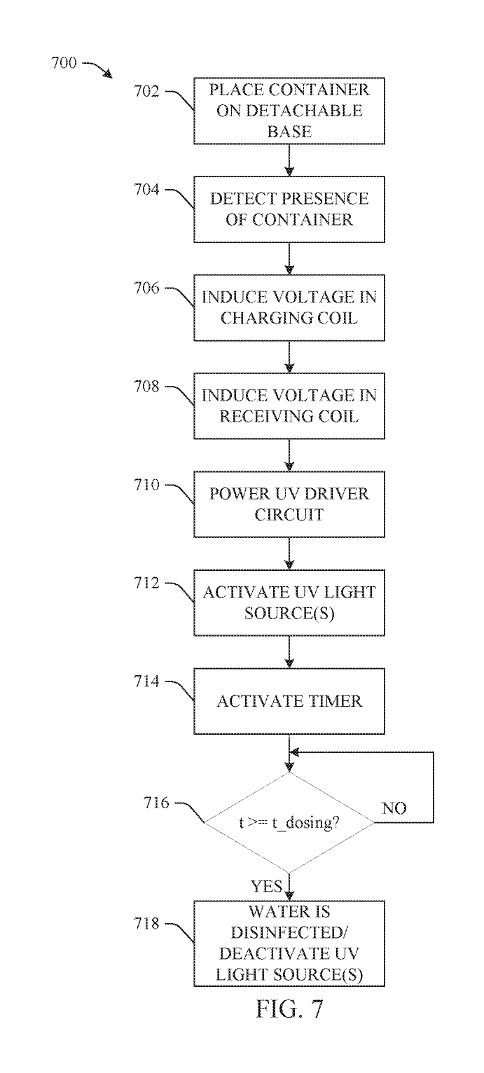

Referring to FIG. 7, a method 700 of disinfecting liquid inside the liquid holding device 120 will now be described. For purposes of illustration only, it is assumed that the rechargeable power source 206 is already in a charged state. At 702, the liquid holding device 120 is set on the detachable base 202. At 704, the proximity detector 212 detects the presence of the liquid holding device 120. At 706, the rechargeable power source 206 induces a voltage in the inductive charging coil 210. At 708, the inductive charging coil 210 induces a voltage in the inductive receiving coil 148. At 710, the inductive receiving coil 148 provides power to the UV driver circuit 146. At 712, the UV driver circuit activates the UV light source(s) 142 and any other applicable peripheral component disclosed herein. At 714, the indicating device 152 is activated. At 716, it is determined if a time t is greater than or equal to a predetermined dosing time t_{dosing}. If “NO,” then the UV light source(s) remain activated and the determination if the time t is greater than or equal to the dosing time t_{dosing} is repeated until t is greater than or equal to t_{dosing}. If at 716 the time t is greater than or equal to the dosing time t_{dosing}, then at 718, the UV light source(s) 142 are deactivated and the indicating device 152 indicates that the liquid is disinfected. The predetermined dosing time t_{dosing} can be a predetermined amount of time required to disinfect a certain quantity of the liquid. The predetermined dosing time t_{dosing} can also be the time required to expose the liquid to a certain amount of UV energy, which is measured by the UV detector 150 described above.

In another embodiment, the system may delay the disinfection process for a time t_{delay} until the UV light source(s) 142 reach their maximum output. A UV light sensor 608 (see FIG. 6) may be included that measures the amount of light a_{light} reaching the sensor 608 and sets the dosing time t_{dosing} by the output of the UV light sensor 608 (t_{dosing}=f(a_{light})). As described above, the system then determines if the time t is greater than the dosing time t_{dosing}. If “YES”, the UV light source(s) 142 are deactivated and the indicating device 152 is activated or engaged thereby indicating that the cycle is complete and the water is disinfected. If “NO,” then the UV light source(s) remain activated and the determination if the time t is greater than or equal to the dosing time t_{dosing} is repeated until t is greater than or equal to t_{dosing}.

Referring to Table 2 below, the innovative liquid purification system disclosed herein was tested by an independent laboratory to verify effectiveness of water treatment. Four (4) mL of each concentrated bacterial culture and 0.040 mL of concentrated MS2 virus sample were mixed into 4.0 liters of de-chlorinated municipal water. 1.2 liters of the contaminated water was placed in the liquid holding device, which was covered and sealed shut. The liquid holding device was placed on the detachable charging base, the timer was initiated and the UV detector began measuring UV output from the UV light source(s). Once the UV detector had detected enough output of energy, the timer indicated that the treatment cycle was done and the UV light source(s) shut off. Initial contaminated sample and purified final sample were assayed for the respective challenge species as per standard methods (APHA, 2012 and EPA 1602). The test was repeated two (2) times for statistical accuracy and the results are displayed in Table 2. The purifier achieved at least 99.99% (4-log) reduction of virus and 99.9999% (6-log) reduction of bacteria.

TABLE 2
Experimental Data
UV Liquid Purification System Inactivation Efficacy Study

| | | | | Initial | Concentration following | |
|---|---|---|---|---|---|---|
| | | | | Concentration | cycle completion | |
| Test | Cycle | | Biological | (cfu/ml for bacteria | (cfu/ml for bacteria | Percent |
| Trial | Time | | Contaminant | and pfu/ml for virus) | and pfu/ml for virus) | Reduction |
| 1 | 5 | min | Raoutella | 4.7 × 10⁵ | <0.45 | >99.9999% |
| | 41 | sec | terrigena 33257 | | | |
| | | | MS2 bacteriophage | 4.6 × 10⁵ | 12.7 | 99.997% |
| | | | 15597-B1 | | | |
| 2 | 5 | min | Raoutella | 4.4 × 10⁵ | <0.45 | >99.9999% |
| | 33 | sec | terrigena 33257 | | | |
| | | | MS2 bacteriophage | 3.8 × 10⁵ | 8.2 | 99.998% |
| | | | 15597-B1 | | | |
| 3 | 5 | min | Raoutella | 4.2 × 10⁵ | <0.45 | >99.9999% |
| | 32 | sec | terrigena 33257 | | | |
| | | | MS2 bacteriophage | 4.3 × 10⁵ | 6.4 | 99.998% |
| | | | 15597-B1 | | | |

FIGS. 8-14 illustrate another example embodiment of a liquid purification system in accordance with an aspect of the innovation. The innovative liquid purification system is similar to the liquid purification system described above and illustrated in FIGS. 1-5. Thus, although different reference numbers will be used to identify like components, the like components will not be described in detail.

The innovative liquid purification system includes a liquid treatment apparatus 800 and a power-generating system 900 in accordance with an aspect of the innovation. The liquid treatment apparatus 800 includes a liquid holding device (e.g., a container, vessel, a bottle, etc.) 820 configured to hold a liquid, such as but not limited to water and a disinfecting system including one or more UV light source(s).

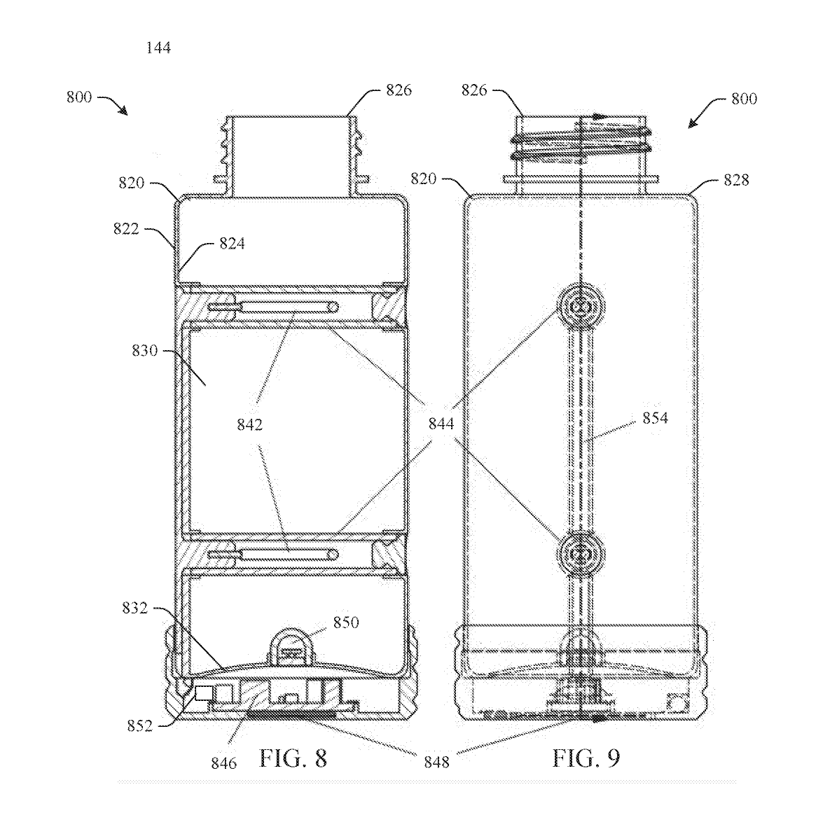

Referring to FIGS. 8 and 9, the liquid holding device 820 has an external surface 822, an internal surface 824, an opening 826 defined at a first end (top) 828, a cavity 830 configured to receive the liquid via the opening 826, and a closed second (bottom) end 832. Among other things, the liquid holding device 820 can function as a disinfection chamber, a drinking vessel, a storage device, a transport device, etc.

The liquid disinfecting system includes one or more UV light source(s) 842 disposed in the liquid holding device 820, protective covers 844 that cover and protect the UV light source(s) 842, a UV driver circuit 846 that drives the UV light source(s) 842, an inductive receiving coil 848 that powers the UV driver circuit 846, and a light sensor 850, and indicating device (e.g., light) 852 that functions as a timer, alarm, a visual and/or audio indicator and that communicates with the light sensor 850.

The UV light source(s) 842 are disposed inside the liquid holding device 820 and placed such that a distance that the radiation travels through the liquid is minimized. Each UV light source 842 is connected to a container base by wires set within a recessed cavity 854. When the liquid holding device 820 is holding liquid, the UV light source(s) 842 disinfect/sanitize the liquid disposed inside the liquid holding device 820 for optimal water treatment and power consumption. When the liquid holding device 820 is empty (not holding liquid), the UV light source(s) 842, when activated, are intended to sanitize the internal surface 824 of the liquid holding device 820.

The protective covers 844 provide protection for the UV light source(s) 842 and may be made from quartz or any protective and transmissive sleeve (or sheath) that transmits UV light in the target wavelength range.

The light sensor 850 measures the transmittance of light through the liquid in order to determine a turbidity of the sample. The indicating device (e.g., display light) 852 serves as a timer, indicating that the minimum amount of time has passed for effective disinfection. The time necessary for disinfection, as indicated by the indicating device 852, is determined based on the turbidity of the sample as determined by the light sensor 850 measuring the transmittance of light within the liquid held in the liquid holding device 820.

A UV detector may be included as described above that measures an output of UV light from the light source(s) 842 to determine an appropriate dosing of UV energy. Once the UV detector has measured an appropriate light dosing to disinfect the volume of liquid, the indicating device 852 alerts the user that a minimum amount of time has passed for effective disinfection.

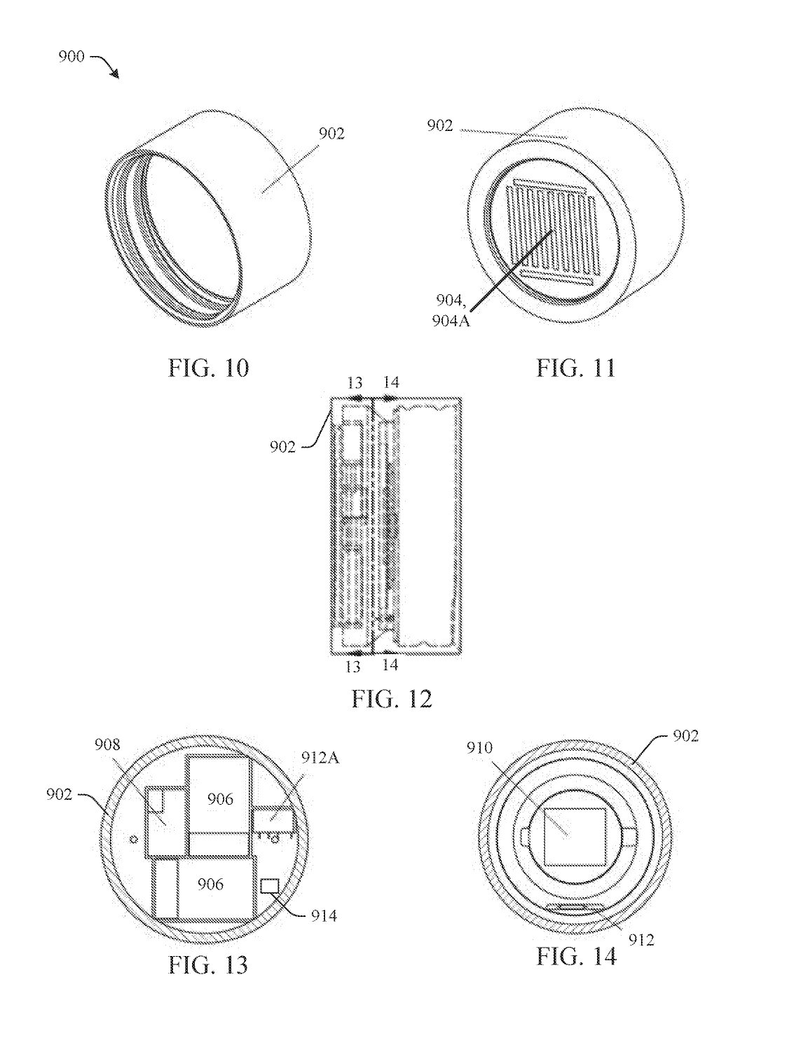

Referring to FIGS. 10-14, the power-generating system 900 is a detachable power source that utilizes wireless transfer of energy to power the UV driver circuit 846 described above. The power generating system 900 is housed in a detachable base 902 that can be coupled to the liquid holding device 820 by any suitable means, such as but not limited to a mechanical means, magnetic means, etc. The power-generating system 900 includes an charging power source 904, a rechargeable power source (e.g., batteries) 906, a voltage controller 908, an inductive charging coil 910, and a proximity sensor 912 and a proximity relay 912A that detect the proximity of the inductive receiving coil 848 and UV driver circuit 846 when the power-generating system 900 is attached to the liquid holding device 820. A battery indicator 914 (e.g., digital, LED, etc.) can be provided to indicate battery life.

The charging power source 904 provides power to the rechargeable power source 906 to thereby recharge the rechargeable power source 906. The charging power source 904 may be any power source, such as but not limited to, a photovoltaic cell 904A, a USB connection 204B, as shown in FIG. 3, a mechanical device (e.g., spring, crank, etc.), batteries, etc.

The voltage controller 908 converts the fixed voltage from the rechargeable power source 906 to a variable voltage to thereby induce a voltage in the inductive charging coil 910. The inductive charging coil 910 electrically couples with the inductive receiving coil 848, which allows the wireless transmission of power from the inductive charging coil 910 to the inductive receiving coil 848. The inductive receiving coil 848 provides power to the UV driver circuit 846, which in turn provides power to the UV light sources 842, as described above.

Referring to Table 3 below, the innovative liquid purification system disclosed herein was tested by an independent laboratory to verify effectiveness of water treatment. One (1) mL of each concentrated bacterial culture and 0.030 mL of concentrated MS2 virus sample were mixed into 3.0 liters of de-chlorinated municipal water. 1.0 liters of the contaminated water was placed in the liquid holding device, which was covered and sealed shut. The UV light source(s) were illuminated for three (3) minutes per 1-L sample. At the end of three (3) minutes, the UV light source(s) were shut off, the water was well-mixed and a sample of water was taken. Initial contaminated sample and purified final sample were assayed for the respective challenge species as per standard methods (APHA, 2012 and EPA 1601). Each analysis was conducted in duplicates for each volume. The test was repeated two (2) times for statistical accuracy and the results are displayed in Table 2. The purifier achieved at least 99.9% (3-log) reduction of virus and 99.99% (4-log) reduction of bacteria.

TABLE 3
Experimental Data

| | | Initial | Concentration following | |
|---|---|---|---|---|
| | | Concentration | cycle completion | |
| Cycle | Biological | (cfu/ml for bacteria | (cfu/ml for bacteria | Percentage |
| Time | Contaminant | and pfu/ml for virus) | and pfu/ml for virus) | Reduction |
| 3 | Staphylococcus | 4.5 × 10⁴ | <0.5 | >99.999% |
| Minutes | aureus 6538 | | | |
| | Salmonella | 4.1 × 10⁵ | 5.5 | 99.999% |
| | enterica 10708 | | | |
| | Escherichia coli | 3.4 × 10⁵ | 6.5 | 99.998% |
| | 35150 | | | |
| | MS2 bacteriophage | 1.7 × 10⁵ | 94.5 | 99.94% |
| | 15597-B1 | | | |
| 3 | Staphylococcus | 4.0 × 10⁴ | <0.5 | >99.999% |
| Minutes | aureus 6538 | | | |
| | Salmonella | 3.5 × 10⁵ | 1 | 99.9997% |
| | enterica 10708 | | | |
| | Escherichia coli | 2.1 × 10⁵ | 3.5 | 99.998% |
| | 35150 | | | |
| | MS2 bacteriophage | 1.5 × 10⁵ | 143.6 | 99.90% |
| | 15597-B1 | | | |
| 3 | Staphylococcus | 1.4 × 10⁵ | <0.5 | >99.9996% |
| Minutes | aureus 6538 | | | |
| | Salmonella | 4.2 × 10⁵ | <0.5 | >99.9999% |
| | enterica 10708 | | | |
| | Escherichia coli | 2.8 × 10⁵ | 0.5 | 99.9998% |
| | 35150 | | | |
| | MS2 bacteriophage | 1.8 × 10⁵ | 51.8 | 99.97% |
| | 15597-B1 | | | |

It is apparent to those skilled in the art that mechanisms in the operation of the apparatus may be reordered, substituted, or excluded or have additional mechanisms inserted without departing from the essence and scope of the invention. Changes in detail or shape of the apparatus will also not depart from the purpose of the invention as defined in the following claims.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A liquid purification system comprising:
a liquid holding device configured to hold liquid;
an ultra-violet (UV) disinfecting system disposed in a base adjacent to a closed end of the liquid holding device; and
a power-generating system that wirelessly powers the UV disinfecting system,
wherein the UV disinfecting system includes at least one UV light source that when activated disinfects the liquid.

2. The system of claim 1, wherein the UV disinfecting system includes an inductive receiving coil and a driver circuit, wherein the inductive receiving coil powers the driver circuit and the driver circuit powers the at least one UV light source.

3. The system of claim 2, wherein the power-generating system is housed in a detachable base and includes an inductive charging coil that induces a voltage in the inductive receiving coil thereby allowing the inductive receiving coil to power the driver circuit.

4. The system of claim 3, wherein the power-generating system further includes a charging power source and a rechargeable power source, wherein the charging power source powers the rechargeable power source and the rechargeable power source powers the inductive charging coil.

5. The system of claim 1, wherein the power-generating system is housed in a detachable base and includes a proximity detector that detects when the liquid holding device is on the detachable base.

6. The system of claim 1 further comprising a waterproof protective base that houses the disinfecting system, wherein the waterproof protective base is seal-tight to prevent water damage to the UV disinfecting system when the liquid holding device is submerged in the liquid in order to fill the liquid holding device.

7. The system of claim 1 further comprising a turbidity meter that determines a minimum amount of UV exposure time for proper disinfection.

8. The system of claim 1, wherein the UV disinfecting system includes a UV detector.

9. The system of claim 8, wherein the UV disinfecting system further includes an indicating device and wherein the UV detector measures an output of UV light from the at least one UV light source and communicates to the indicating device that an acceptable amount of time has passed for effective disinfection.

10. The system of claim 1, wherein the liquid holding device is a portable device in that it can be easily carried by a person.

11. A liquid treatment apparatus comprising:
a portable liquid holding device configured to hold liquid;
at least one ultra-violet (UV) light source that when activated disinfects the liquid; and
an inductive coil that receives power from an external power source to thereby power the at least one UV light source.

12. The apparatus of claim 11 further comprising a waterproof protective base that houses the at least one UV light source adjacent to a closed end of the portable liquid holding device, wherein the waterproof protective base is seal-tight to prevent water damage to the at least one UV light source when the portable liquid holding device is submerged in the liquid in order to fill the liquid holding device.

13. The apparatus of claim 11 further comprising an inductive receiving coil and a driver circuit housed in the waterproof protective base, wherein the inductive receiving coil receives power from an external power source to power the driver circuit, and wherein the driver circuit powers the at least one UV light source.

14. The apparatus of claim 11 further comprising a UV detector and an indicating device housed in the waterproof protective base and wherein the UV detector measures an output of UV light from the at least one UV light source and communicates to the indicating device that an acceptable amount of time has passed for effective disinfection.

15. The apparatus of claim 11 further comprising a mixing device disposed within the portable liquid holding device that agitates the liquid to ensure uniform disinfection.

16. The apparatus of claim 11 further comprising a turbidity meter that determines a minimum amount of UV exposure time for proper disinfection.

17. A method of disinfecting a liquid comprising:
setting a liquid holding device on a power generating base;
detecting the presence of the liquid holding device on the power generating base with a proximity detector;
inducing a voltage in an inductive charging coil from a rechargeable power source;
wirelessly inducing a voltage in an inductive receiving coil from the inductive charging coil;
powering a driver circuit from the inductive receiving coil;
activating the at least one ultra-violet (UV) light source from the driver circuit; and
disinfecting the liquid inside the liquid holding device.

18. The method of claim 18 further comprising determining if a time that the at least one UV light source has been activated is greater than or equal to a predetermined dosing time.

19. The method of claim 18 further comprising activating an indicating device and measuring UV light from the at least one UV light source with a UV light detector.

20. The method of claim 19 further comprising determining if the measured amount of UV light from the at least one UV light source is an appropriate amount of UV energy exposure to disinfect the liquid.
